(19) United States
(12) Patent Application Publication
(10) Pub. No.: US 2019/0277215 A1
(43) Pub. Date: Sep. 12, 2019

(54) CONTROLLER FOR INTERNAL COMBUSTION ENGINE AND METHOD FOR CONTROLLING INTERNAL COMBUSTION ENGINE

(71) Applicant: TOYOTA JIDOSHA KABUSHIKI KAISHA, Toyota-shi (JP)

(72) Inventor: Hiroya TANAKA, Nagoya-shi (JP)

(73) Assignee: TOYOTA JIDOSHA KABUSHIKI KAISHA, Toyota-shi (JP)

(21) Appl. No.: 16/292,389

(22) Filed: Mar. 5, 2019

(30) Foreign Application Priority Data
Mar. 8, 2018 (JP) 2018-041847

(51) Int. Cl. F02D 41/14; F02D 41/12

(52) U.S. Cl. CPC F02D 41/1402; F02D 2041/1409; F02D 41/123; F02D 41/1441

(57) ABSTRACT

A controller for an internal combustion engine includes processing circuitry. The processing circuitry executes a fuel cut-off process that stops supply of fuel to a combustion chamber of the internal combustion engine when an accelerator operation amount is less than or equal to a predetermined amount and a rotation speed of a crankshaft is in a predetermined speed range. The processing circuitry executes an widening process that widens the predetermined speed range when a decrease rate of the rotation speed of the crankshaft is less than or equal to a specified rate as compared to when the decrease rate is greater than the specified rated.

### BACKGROUND

The present disclosure relates to a controller for an internal combustion engine and a method for controlling an internal combustion engine.

For example, Japanese Laid-Open Patent Publication No. 2015-124625 discloses a controller for an internal combustion engine that executes a fuel cut-off process as described below. The controller is mounted on a vehicle that does not include a sensor detecting release of a clutch. The condition for executing the fuel cut-off process is a state in which a depression amount of an accelerator pedal (accelerator operation amount) is less than or equal to a threshold value that is close to zero and a rotation speed of a crankshaft of an internal combustion engine is greater than or equal to a predetermined rotation speed. When an amount of change in the rotation speed is in a predetermined range, the clutch is considered to be in a coupled state. On the other hand, when the amount of change in the rotation speed is outside the predetermined range, the clutch is considered to be in a released state. When the condition for executing the fuel cut-off process is satisfied in a state in which the amount of change in the rotation speed is in the predetermined range, the controller executes the fuel cut-off process after a delay time elapses from when the condition for executing the fuel cut-off process is satisfied. When the condition for executing the fuel cut-off process is satisfied in a state in which the amount of change in the rotation speed is outside the predetermined range, the controller immediately executes the fuel cut-off process.

Output from the crankshaft is received by a manual transmission via the clutch and transmitted to the output side of the manual transmission. When the crankshaft is in a connected state, the output of the crankshaft is transmitted to the output side of the manual transmission. When the crankshaft is in a disconnected state, the output of the crankshaft is not transmitted to the output side of the manual transmission. For example, when the clutch is in the released state, the crankshaft is in the disconnected state. For example, when the manual transmission is in a neutral state, the crankshaft is in the disconnected state. When the crankshaft is in the disconnected state, the decrease rate of the rotation speed of the crankshaft is greater than when the crankshaft is in the connected state. Thus, for example, in order to avoid an engine stall, when the crankshaft is in the disconnected state, a return rotation speed, which is a rotation speed at which the fuel cut-off process is stopped, needs to be set in accordance with the decrease rate of the rotation speed of the crankshaft that is in the disconnected state. Additionally, when the crankshaft is in the disconnected state, a permit rotation speed, which is a lower limit value of the rotation speed at which the fuel cut-off process is started, needs to be set in accordance with the decrease rate of the rotation speed of the crankshaft that is in the disconnected state so that the fuel cut-off process continues for a certain amount of time. If the return rotation speed and the permit rotation speed, which are used in the disconnected state of the crankshaft, are also used in the connected state of the crankshaft, the return rotation speed and the permit rotation speed may become excessively high when the crankshaft is in the connected state. For example, when it cannot be determined whether the crankshaft is in the disconnected state or the connected state, the return rotation speed and the permit rotation speed that are used in the disconnected state of the crankshaft need to be used in the connected state of the crankshaft. In such a case, the fuel cut-off process may not be started at a rotation speed at which the fuel cut-off process is permitted to start in the connected state without causing problems. Also, the fuel cut-off process may be stopped at a rotation speed at which the fuel cut-off process is allowed to continue. This may adversely affect fuel consumption.

### SUMMARY

Aspects of the present disclosure and operations and effects of the aspects will now be described.

Aspect 1. One aspect of the present disclosure provides a controller for an internal combustion engine. The internal combustion engine is mounted on a vehicle and includes a crankshaft. The crankshaft is configured to be connected to a manual transmission via a clutch. The controller includes processing circuitry. The processing circuitry is configured to perform executing a fuel cut-off process that stops supply of fuel to a combustion chamber of the internal combustion engine when an accelerator operation amount is less than or equal to a predetermined amount and a rotation speed of the crankshaft is in a predetermined speed range, setting a lower limit value of the predetermined speed range to a permit rotation speed during non-execution of the fuel cut-off process, setting the lower limit value of the predetermined speed range to a return rotation speed during execution of the fuel cut-off process, the return rotation speed being lower than the permit rotation speed, and executing an widening process that widens the predetermined speed range when a decrease rate of the rotation speed of the crankshaft is less than or equal to a specified rate as compared to when the decrease rate is greater than the specified rate. The widening process includes a process that lowers at least one of the permit rotation speed and the return rotation speed.

When the decrease rate of rotation speed of the crankshaft is smaller than the specified rate, it is highly likely that the crankshaft is connected to an output shaft side of a manual transmission. In other words, the crankshaft is considered to be in a connected state. When the decrease rate of the rotation speed of the crankshaft is greater than the specified rate, it is highly likely that the crankshaft is not connected to the output shaft side of the manual transmission. In other words, the crankshaft is considered to be in a disconnected state. The decrease rate of the rotation speed of the crankshaft when the fuel cut-off process is executed in the connected state of the crankshaft tends to be smaller than the decrease rate of the rotation speed of the crankshaft when the fuel cut-off process is executed in the disconnected state of the crankshaft. According to the configuration described above, when the crankshaft is considered to be in the connected state, the predetermined speed range for executing the fuel cut-off process is widened toward a low speed side. This enhances the effect of decreasing fuel consumption amount.

Aspect 2. In the controller according to aspect 1, the widening process may include a process that sets a difference between the permit rotation speed and the return rotation speed to a smaller value when the decrease rate is less than or equal to the specified rate than when the decrease rate is greater than the specified rate.

The decrease rate of the rotation speed of the crankshaft when the fuel cut-off process is executed in the connected state of the crankshaft is smaller than the decrease rate of the rotation speed of the crankshaft when the fuel cut-off process is executed in the disconnected state of the crankshaft. Thus, when the fuel cut-off process is executed in the connected state of the crankshaft, it takes a longer time to decrease the rotation speed of the crankshaft from the permit rotation speed to the return rotation speed. Therefore, according to the configuration described above, when the decrease rate of the rotation speed of the crankshaft is less than or equal to the specified rate, the difference between the permit rotation speed and the return rotation speed is set to a small value. As a result, when the crankshaft is in the connected state, at least one of the permit rotation speed and the return rotation speed is decreased as compared to when the crankshaft is in the disconnected state. More specifically, the range of rotation speeds that permit execution of the fuel cut-off process is widened in the connected state of the crankshaft.

Aspect 3. In the controller according to aspect 1 or 2, the processing circuitry may be configured to execute a temperature reflection process that sets the return rotation speed to a larger value when a temperature of the internal combustion engine is low than when the temperature of the internal combustion engine is high. When the temperature of the internal combustion engine is a first temperature, the return rotation speed is a first return rotation speed. When the temperature of the internal combustion engine is a second temperature that is lower than the first temperature, the return rotation speed is a second return rotation speed. The widening process may include a process that sets a difference between the first return rotation speed and the second return rotation speed to a smaller value when the decrease rate is less than or equal to the specified rate than when the decrease rate is greater than the specified rate.

At a low temperature, a large frictional force is generated in sliding portions of the internal combustion engine. Thus, the fuel cut-off process readily decreases the rotation speed of the crankshaft. According to the configuration described above, the temperature reflection process sets the return rotation speed to a large value at a low temperature. In the disconnected state of the crankshaft, even after the fuel cut-off process is stopped, the rotation speed of the crankshaft is more prone to undershoot as the temperature becomes lower. Accordingly, an engine stall may occur at low temperatures. In the connected state of the crankshaft, the crankshaft is dragged by the output shaft of the manual transmission. Thus, undershoot does not normally occur after the fuel cut-off process is stopped. According to the configuration described above, when the decrease rate is greater than the specified rate, the second return rotation speed is set to be a further larger value in relation to the first return rotation speed than when the decrease rate is less than or equal to the specified rate. This configuration limits an excessive decrease in the rotation speed after the fuel cut-off process is stopped in the disconnected state of the crankshaft. Moreover, in the connected state of the crankshaft, the second return rotation speed is set to be lower than in the disconnected state of the crankshaft. This maximizes the duration of the fuel cut-off process.

Aspect. 4 In the controller according to any one of aspects 1 to 3, the processing circuitry may be configured to execute a vehicle speed reflection process that sets the return rotation speed to a larger value when a vehicle speed is low than when the vehicle speed is high. The vehicle speed reflection process may include a process that sets the return rotation speed to a larger value when the vehicle speed is lower than a predetermined vehicle speed than when the vehicle speed is greater than or equal to the predetermined vehicle speed. The widening process may include a process that sets the predetermined vehicle speed to a further lower value when the decrease rate is less than or equal to the specified rate than when the decrease rate is greater than the specified rate.

When the crankshaft is in the connected state, the crankshaft is dragged by the output shaft of the manual transmission. Thus, the predetermined vehicle speed may be set based on the lower limit rotation speed at which the rotation speed of the crankshaft is controllable at a stop of the fuel cut-off process. On the other hand, when the fuel cut-off process is executed in the disconnected state of the crankshaft and then the crankshaft is brought into the connected state at a low vehicle speed, the rotation speed of the crankshaft may be dropped. When the rotation speed of the input shaft of the manual transmission is low, such a drop is more significant than when the rotation speed of the input shaft is high. Thus, an engine stall may occur when the rotation speed of the input shaft is low. According to the configuration described above, when the decrease rate is greater than the specified rate, the predetermined vehicle speed is set to a higher speed than when the decrease rate is less than or equal to the specified rate. As a result, when the crankshaft is considered to be in the disconnected state, an excessive decrease in the rotation speed is limited when the fuel cut-off process is executed. Moreover, when the crankshaft is considered to be in the connected state, the return rotation speed is set further toward the low speed side in relation to the vehicle speed. This maximizes the duration of the fuel cut-off process.

Aspect 5. In the controller according to any one of aspects 1 to 4, the widening process may include a process that lowers the return rotation speed on a condition that a gear position of the manual transmission is a predetermined gear position or higher.

When the rotation speed of the internal combustion engine is low, time intervals between combustion strokes are longer than when the rotation speed of the internal combustion engine is high. This adversely affects the controllability of torque control in a short time. When the gear position is low, a change in shaft torque of the internal combustion engine is more readily sensed than when the gear position is high. Thus, an abrupt change in torque caused by a stop of the fuel cut-off process is noticeable particularly when the fuel cut-off process is executed in a low rotation range at a low gear position. Thus, according to the configuration described above, a state where the gear position is a predetermined gear position or higher is added to the condition for executing the process that lowers the return rotation speed. This reduces abrupt changes in torque caused by a stop of the fuel cut-off process.

Aspect 6. In the controller according to any one of aspects 1 to 4, the widening process may include a process that widens the predetermined speed range on a condition that a clutch sensor detects that the clutch is in a coupled state.

Even when the clutch sensor detects that the clutch is in the coupled state, if the manual transmission is in neutral state, the fuel cut-off process lowers the rotation speed of the crankshaft more readily than when the crankshaft is in the connected state. Thus, if the widening process is executed based on only the detection of the coupled state of the clutch by the clutch sensor, the fuel cut-off process may result in an excessive decrease in the rotation speed of the crankshaft. With the configuration described above, even when the coupled state of the clutch is detected, the widening process is executed based on a condition that the decrease rate is less than or equal to the specified rate. This configuration limits the excessive decrease in the rotation speed of the crankshaft caused by the fuel cut-off process as compared to a configuration that executes the widening process based on only the detection of the coupled state of the clutch by the clutch sensor.

Aspect. 7 One aspect of the present disclosure provides a method for controlling an internal combustion engine. The internal combustion engine is mounted on a vehicle and includes a crankshaft. The crankshaft is configured to be connected to a manual transmission via a clutch. The method includes executing a fuel cut-off process that stops supply of fuel to a combustion chamber of the internal combustion engine when an accelerator operation amount is less than or equal to a predetermined amount and a rotation speed of the crankshaft is in a predetermined speed range, setting a lower limit value of the predetermined speed range to a permit rotation speed during non-execution of the fuel cut-off process, setting the lower limit value of the predetermined speed range to a return rotation speed during execution of the fuel cut-off process, the return rotation speed being lower than the permit rotation speed, and executing an widening process that widens the predetermined speed range when a decrease rate of the rotation speed of the crankshaft is smaller than or equal to a specified rate as compared to when the decrease rate is greater than the specified rate. The widening process includes a process that lowers at least one of the permit rotation speed and the return rotation speed.

Aspect. 8 One aspect of the present disclosure provides a controller for an internal combustion engine. The internal combustion engine is mounted on a vehicle and includes a crankshaft. The crankshaft is configured to be connected to a manual transmission via a clutch. The controller includes processing circuitry configured to execute a fuel cut-off process that stops supply of fuel to a combustion chamber of the internal combustion engine. The processing circuitry is configured to perform executing the fuel cut-off process when an accelerator operation amount is less than or equal to a predetermined amount and a rotation speed of the crankshaft is greater than or equal to a permit rotation speed during non-execution of the fuel cut-off process, stopping the fuel cut-off process when the accelerator operation amount is larger than the predetermined amount or the rotation speed of the crankshaft is lower than a return rotation speed during execution of the fuel cut-off process, the return rotation speed being lower than the permit rotation speed, and executing a process that lowers at least one of the permit rotation speed and the return rotation speed when a decrease rate of the rotation speed of the crankshaft is less than or equal to a specified rate.

### BRIEF DESCRIPTION OF THE DRAWINGS

The disclosure, together with objects and advantages thereof, may best be understood by reference to the following description of the presently preferred embodiments together with the accompanying drawings in which:

FIG. 1 is a diagram showing a controller and a part of a driving system of a vehicle according to an embodiment;

FIG. 2 is a block diagram showing some of the processes executed by the controller in FIG. 1;

FIG. 3 is a chart showing data used in a gear position estimation process executed by the controller in FIG. 1;

FIG. 4 is a flowchart showing the procedures of a determination execution process executed by the controller in FIG. 1;

FIG. 5 is a chart showing an arithmetic process in a speed calculation process executed by the controller in FIG. 1;

FIG. 6 is a chart showing an arithmetic process in the speed calculation process executed by the controller in FIG. 1;

FIG. 7 is a flowchart showing the procedures of the speed calculation process executed by the controller in FIG. 1;

FIG. 8 is a time chart showing a behavior of a rotation speed in a neutral state according to the embodiment in FIG. 1;

FIG. 9 is a time chart showing an effect of the embodiment in FIG. 1;

FIG. 10 is a chart showing an effect of the embodiment in FIGS. 1; and

FIGS. 11A and 11B are time charts each showing an effect of the embodiment in FIG. 1.

### DETAILED DESCRIPTION

An embodiment of a controller for an internal combustion engine will now be described with reference to the drawings.

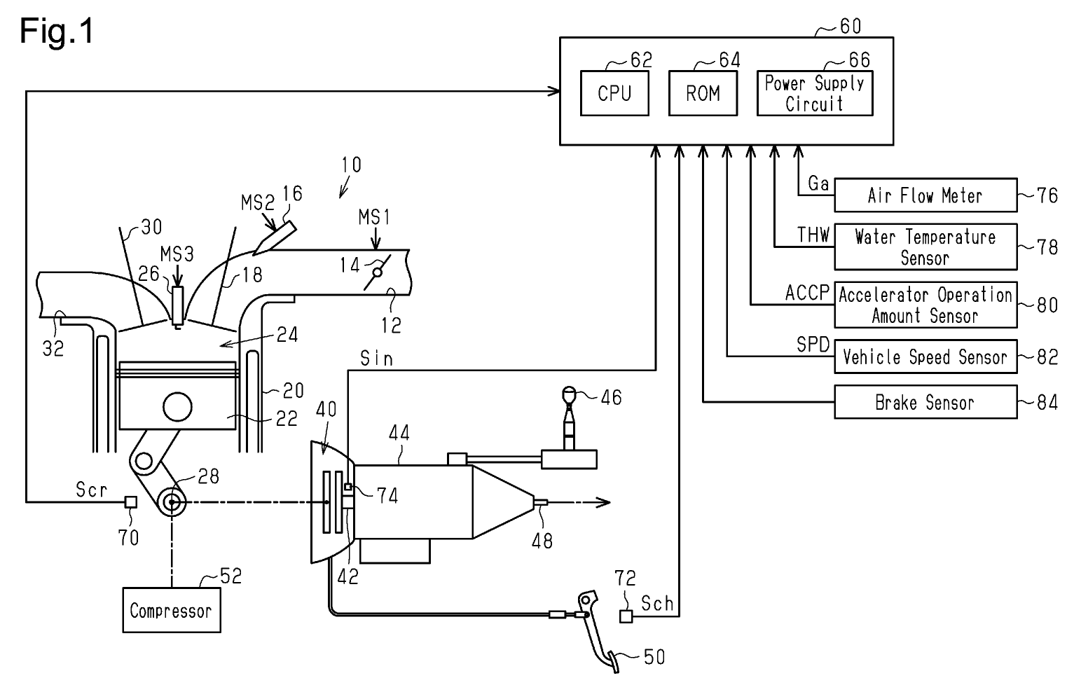

As shown in FIG. 1, a throttle valve 14 is provided in an intake passage 12 of an internal combustion engine 10. A fuel injection valve 16 is provided on the downstream side of the throttle valve 14. Fuel injected from the fuel injection valve 16 and air drawn into the intake passage 12 flow into a combustion chamber 24 defined by a cylinder 20 and a piston 22 in accordance with opening of an intake valve 18. The air-fuel mixture in the combustion chamber 24 is subjected to combustion by spark discharge of an ignition device 26. Energy generated by the combustion is converted into rotational energy of a crankshaft 28 via a piston 22. The air-fuel mixture subjected to the combustion is discharged to an exhaust passage 32 as exhaust gas in accordance with opening of an exhaust valve 30.

The crankshaft 28 is connected to an input shaft 42 of a manual transmission 44 via a clutch 40. The manual transmission 44 changes an engagement state of gears transmitting driving force so that the transmission ratio, which is a ratio of a rotation speed of the input shaft 42 to a rotation speed of an output shaft 48, is changed in accordance with an operation of a shift lever 46 performed by the user. In accordance with an operation of a clutch pedal 50, the clutch 40 switches between a coupled state that integrally rotates the crankshaft 28 and the input shaft 42 and a released state that interrupts power transmission between the crankshaft 28 and the input shaft 42.

The output shaft 48 of the manual transmission 44 is connected to drive wheels. The crankshaft 28 is connected to a compressor 52 of an onboard air conditioner.

The controller 60 is capable of controlling the internal combustion engine 10 and operates operation units of the internal combustion engine 10, such as the throttle valve 14, the fuel injection valve 16, and the ignition device 26, to control the control variables of the internal combustion engine 10 such as torque and exhaust components.

When controlling the control variables, the controller 60 refers to an output signal Scr of a crank angle sensor 70, an output signal Sch of a clutch sensor 72 that detects binary values indicating whether or not the clutch pedal 50 is depressed, and an output signal Sin of an input rotation angle sensor 74 that detects a rotation angle of the input shaft 42. The controller 60 also refers to an intake air amount Ga detected by an air flow meter 76, a temperature of cooling water of the internal combustion engine 10 (water temperature THW) detected by a water temperature sensor 78, and an accelerator pedal depression amount (accelerator operation amount ACCP) detected by an accelerator operation amount sensor 80. The controller 60 also refers to a vehicle speed SPD detected by a vehicle speed sensor 82 and a detection result detected by a brake sensor 84 indicating whether or not a brake pedal is depressed. A large value of the accelerator operation amount ACCP requests the internal combustion engine 10 to generate a large torque.

The controller 60 includes a central processing unit (CPU) 62, a read-only memory (ROM) 64, and a power supply circuit 66 that supplies electric power to each part in the controller 60. The CPU 62 executes programs stored in the ROM 64 to control the above-described control variables.

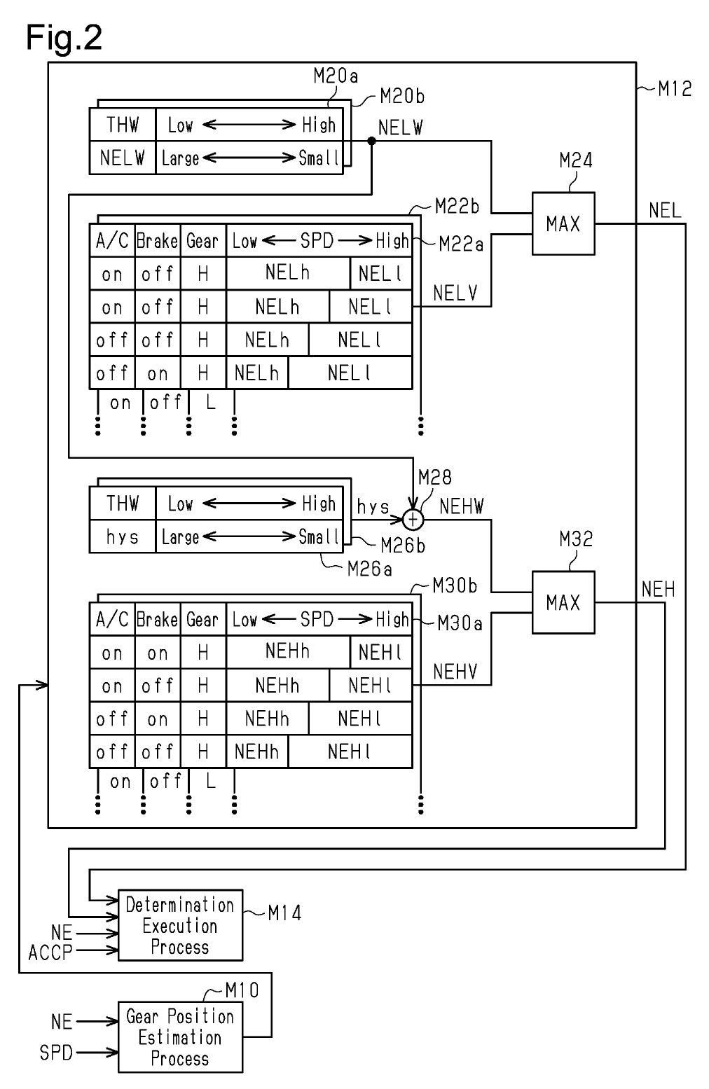

FIG. 2 shows some of the processes executed by the controller 60. The processes shown in FIG. 2 are implemented under programs stored in ROM 64 and executed by the CPU 62.

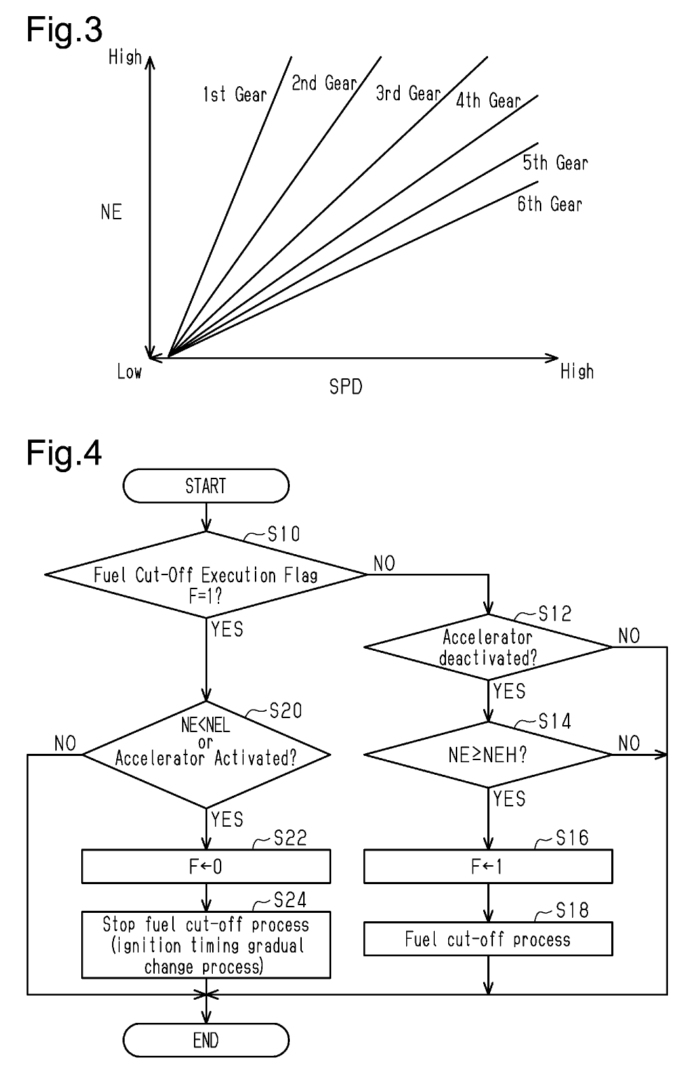

A gear position estimation process M10 is a process that estimates the gear position of the manual transmission 44 based on a rotation speed NE of the crankshaft 28 and the vehicle speed SPD. FIG. 3 shows a relationship between the rotation speed NE and the vehicle speed SPD and the gear position. For example, the gear position includes a first gear, a second gear, and so on.

When the gear position is fixed, the vehicle speed SPD and the rotation speed NE have a proportional relationship as shown in FIG. 3. Thus, the gear position estimation process M10 estimates the gear position by determining which gear position relationship shown in FIG. 3 is close to the relationship of the rotation speed NE and the vehicle speed SPD. For example, the gear position estimation process M10 may be executed based on data specifying the relationship between the vehicle speed SPD and the rotation speed NE for each gear position stored beforehand in the ROM 64. More specifically, while referring to this data, the CPU 62 retrieves, for each gear position, a value of the vehicle speed SPD specified from the rotation speed NE acquired each time. The CPU 62 selects a gear position that minimizes the absolute value of the difference between the retrieved value of the vehicle speed SPD and the actual value of the vehicle speed SPD. The rotation speed NE is calculated by the CPU 62 based on the output signal Scr.

Referring to FIG. 2, a speed calculation process M12 is a process for calculating and outputting a permit rotation speed NEH, which is the lower limit value of rotation speeds that permit execution of a fuel cut-off process, and a return rotation speed NEL, which is a threshold value of the rotation speeds at which the fuel cut-off process is stopped. The permit rotation speed NEH is higher than the return rotation speed NEL.

A determination execution process M14 is a process for determining execution and stop of the fuel cut-off process.

FIG. 4 shows the procedures of the determination execution process M14. The process shown in FIG. 4 is implemented under a program stored in the ROM 64 and repeatedly executed by the CPU 62, for example, in a predetermined cycle. In the following description, the step number of each step is represented by a numeral provided with “S” in front.

In the series of processes shown in FIG. 4, the CPU 62 first determines whether or not a fuel cut-off execution flag F is “1” (S10). The fuel cut-off execution flag F being “1” indicates that the fuel cut-off process, which stops an injection of fuel from the fuel injection valve 16, is being executed. The fuel cut-off execution flag F being “0” indicates that the fuel cut-off process is stopped. When it is determined that the fuel cut-off execution flag F is “0” (S10: NO), the CPU 62 determines whether or not the accelerator operation amount ACCP is zero (S12). In other words, the CPU 62 determines whether or not the accelerator is in a deactivated state (S12). When the accelerator is in the deactivated state, the accelerator pedal is not depressed. When it is determined that the accelerator is in the deactivated state (S12: YES), the CPU 62 determines whether or not the rotation speed NE is greater than or equal to the permit rotation speed NEH (S14). The process in S14 is a process that determines whether to permit the fuel cut-off process. When it is determined that the rotation speed NE is greater than or equal to the permit rotation speed NEH (S14: YES), the CPU 62 determines to execute the fuel cut-off process and assigns “1” to the fuel cut-off execution flag F (S16). Thereafter, the CPU 62 starts the fuel cut-off process (S18).

When it is determined that the fuel cut-off execution flag F is “1” (S10: YES), the CPU 62 proceeds to S20. The process in S20 is a process that determines whether to stop the fuel cut-off process, that is, whether to resume the control for injecting fuel from the fuel injection valve 16 and burning the air-fuel mixture in the combustion chamber 24. When it is determined that the rotation speed NE is lower than the return rotation speed NEL or that the accelerator is in an activated state (S20: YES), the CPU 62 determines to stop the fuel cut-off process and assigns “0” to the fuel cut-off execution flag F (S22). When the accelerator is in the activated state, the accelerator operation amount ACCP is not zero. Thereafter, the CPU 62 stops the fuel cut-off process (S24). After stopping the fuel cut-off process, the CPU 62 operates the ignition device 26 to temporarily retard the ignition timing and then gradually advance the ignition timing to limit stepwise increases of shaft torque of the internal combustion engine 10 caused by the stop of the fuel cut-off process.

When the process in S18 or S24 is completed or when a negative determination is made in the process S12, S14, or S20, the CPU 62 temporarily ends the series of processes shown in FIG. 4.

The speed calculation process M12 shown in FIG. 2 includes a process that sets each of the permit rotation speed NEH and the return rotation speed NEL based on whether or not the crankshaft is in a connected state. When the crankshaft is in the connected state, the crankshaft 28 is connected to the output shaft 48 of the manual transmission 44. The controller 60 of the present embodiment includes two types of map data, namely, normal map and wide map, to implement the speed calculation process M12. The map data is a set of data including discrete values of input variables, and values of output variables corresponding to each input variable. For example, when a value of an input variable is matched with any of the values of the input variables in the map data, a map calculation outputs the value of the corresponding output variable in the map data as a calculation result. When the value of the input variable is not matched, a value obtained by interpolating the values of the output variables included in the map data may be output as a calculation result. The wide map is used when the crankshaft 28 is in the connected state. The normal map is used when the crankshaft 28 is in the disconnected state.

More specifically, the map for determining the return rotation speed NEL includes water temperature dependent return rotation speed maps M20a and M20b and vehicle speed dependent return rotation speed maps M22a and M22b. The water temperature dependent return rotation speed is also referred to as a water temperature dependent return speed. The vehicle speed dependent return rotation speed is also referred to as a vehicle speed dependent return speed. The water temperature dependent return speed map M20a and the vehicle speed dependent return speed map M22a are wide maps. The water temperature dependent return speed map M20b and the vehicle speed dependent return speed map M22b are normal maps. Also, the map for determining the permit rotation speed NEH includes hysteresis width maps M26a and M26b and vehicle speed dependent permit rotation speed maps M30a and M30b. The vehicle speed dependent permit rotation speed is also referred to as a vehicle speed dependent permit speed. The hysteresis width map M26a and the vehicle speed dependent permit speed map M30a are wide maps. The hysteresis width map M26b and the vehicle speed dependent permit speed map M30b are normal maps.

Each of the water temperature dependent return speed maps M20a and M20b is map data in which the water temperature THW is an input variable and a water temperature dependent return speed NELW is an output variable. Each of the hysteresis width maps M26a and M26b is map data in which the water temperature THW is an input variable and a hysteresis width hys is an output variable. The water temperature dependent permit rotation speed NEHW is a value obtained by adding the hysteresis width hys calculated by a map calculation based on the hysteresis width maps M26a and M26b to the water temperature dependent return speed NELW calculated by a map calculation based on the water temperature dependent return speed maps M20a and M20b in an addition process M28. The water temperature dependent permit rotation speed is also referred to as a water temperature dependent permit speed.

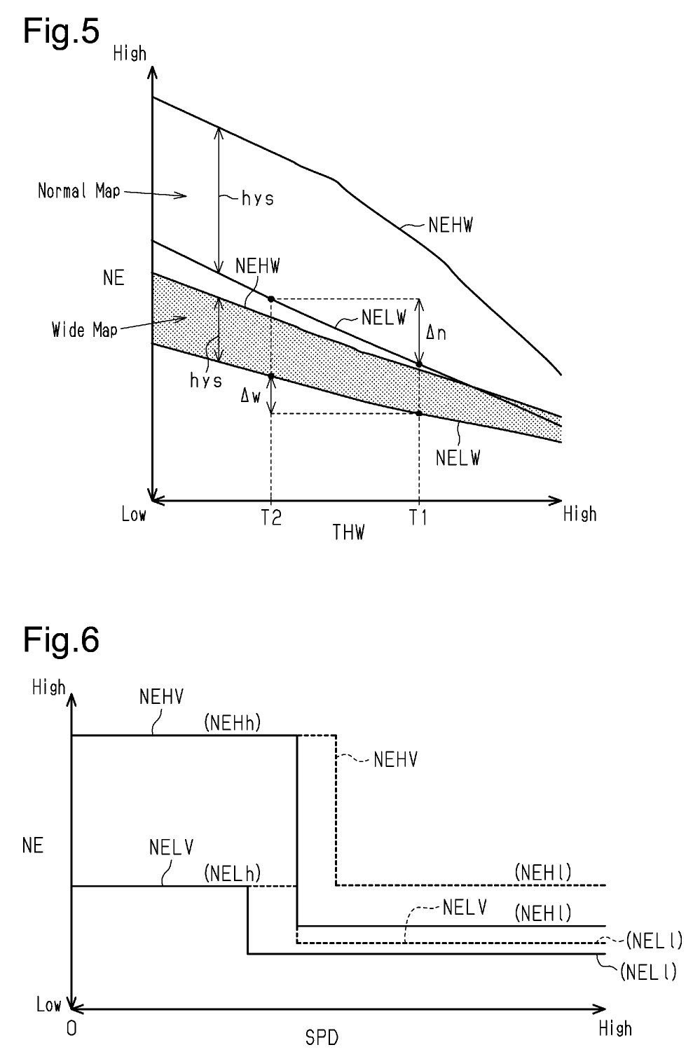

FIG. 5 shows examples of map calculation values of the water temperature dependent return speed NELW, the water temperature dependent permit speed NEHW, and the hysteresis width hys in correspondence with the water temperature THW.

As shown in FIG. 5, when the water temperature THW is low, the water temperature dependent return speed NELW and the water temperature dependent permit speed NEHW determined by the wide map and the water temperature dependent return speed NELW and the water temperature dependent permit speed NEHW determined by the normal map are both set to greater values than when the water temperature THW is high. These settings are made in consideration, for example, that when the water temperature THW is low, combustion of the air-fuel mixture in the combustion chamber 24 is less stable than when the water temperature THW is high, and that when the water temperature THW is low, friction between the sliding parts such as the piston 22 and the cylinder 20 increases more than when the water temperature THW is high. Thus, in the disconnected state of the crankshaft 28, when the water temperature THW is low, the rotation speed of the crankshaft 28 is decreased by the fuel cut-off process more readily than when the water temperature THW is high. If the permit rotation speed NEH is set without considering the water temperature THW in the disconnected state of the crankshaft 28, the time from execution to stop of the fuel cut-off process may be excessively short. If the return rotation speed NEL is set without considering the water temperature THW in the disconnected state of the crankshaft 28, the rotation speed NE may undershoot after the fuel cut-off process is stopped. This may excessively decrease the rotation speed NE and result in an engine stall.

Additionally, in the present embodiment, as shown in FIG. 5, the hysteresis width hys of the wide map is set to a smaller value than the hysteresis width hys of the normal map. When the crankshaft 28 is in the connected state, the crankshaft 28 is dragged by the output shaft 48. Thus, the decrease rate of the rotation speed NE is less than the decrease rate in the disconnected state of the crankshaft 28. This allows the hysteresis width hys of the wide map to be set to a smaller value than the hysteresis width hys of the normal map. When the decrease rate of the rotation speed NE is high, the rotation speed NE readily decreases. For example, the decrease rate of the rotation speed NE may be a decrease amount of the rotation speed NE in a predetermined period. The decrease rate of the rotation speed NE is not limited to the decrease amount and may be any value indicating the degree of easiness of decreasing the rotation speed NE.

As shown in FIG. 5, a difference An between the water temperature dependent return speed NELW at a second temperature T2 and the water temperature dependent return speed NELW at a first temperature T1 in the normal map is larger than a difference Aw between the water temperature dependent return speed NELW at the second temperature T2 and the water temperature dependent return speed NELW at the first temperature T1 in the wide map. The second temperature T2 is lower than the first temperature T1. These settings are made to maximize the duration of the fuel cut-off process while limiting an excessive decrease in the rotation speed after the fuel cut-off process is stopped. More specifically, when the crankshaft 28 is in the disconnected state, even after the fuel cut-off process is stopped, the rotation speed NE is more prone to undershoot as the water temperature THW lowers. However, when the crankshaft 28 is in the connected state, the crankshaft 28 is dragged by the output shaft 48 of the manual transmission 44. Thus, after the fuel cut-off process is stopped, undershoot does not readily occur. Therefore, in the present embodiment, the difference between the water temperature dependent return speed NELW when the water temperature THW is high and the water temperature dependent return speed NELW when the water temperature THW is low is set to be greater in the disconnected state than in the connected state.

Referring to FIG. 2, each of the vehicle speed dependent return speed maps M22a and M22b is map data in which input variables are parameters indicating an air conditioner state, a brake state, whether or not the gear position is higher than or equal to a predetermined gear position, and the vehicle speed SPD, and an output variable is the vehicle speed dependent return speed NELV. When the gear position is higher than or equal to the predetermined gear position, the parameter indicating the gear position is “H.” When the gear position is lower than the predetermined gear position, the parameter indicating the gear position is “L.” In the present embodiment, in the vehicle speed dependent return speed map M22a, the vehicle speed dependent return speed NELV is defined only when the gear position is higher than or equal to the predetermined gear position. However, in the vehicle speed dependent return speed map M22b, the vehicle speed dependent return speed NELV is defined both when the gear position is higher than or equal to the predetermined gear position and when the gear position is lower than the predetermined gear position. These settings are made in the present embodiment because when the crankshaft 28 is in the connected state at the gear position of “L,” the return rotation speed NEL is not set to a smaller value than the return rotation speed NEL in the disconnected state of the crankshaft 28. This setting limits adverse effects on the drivability. More specifically, when the gear position is “L,” a change in shaft torque of the internal combustion engine 10 is transmitted to the drive wheels more readily than when the gear position is “H.” Thus, immediately after the fuel cut-off process is stopped, the user readily senses an increase in torque of the internal combustion engine 10. The CPU 62 executes a process that gradually changes the ignition timing, which is described above, in response to the stop of the fuel cut-off process. However, when the rotation speed NE is low, for example, intervals between compression top dead centers are elongated. Thus, changes in the shaft torque per unit time are not limited as readily as when the rotation speed NE is high. Hence, at the gear position of “L”, even when the crankshaft 28 is in the connected state, the return rotation speed NEL is not set to a smaller value than when the crankshaft 28 is in the disconnected state.

Each of the vehicle speed dependent return speed maps M22a and M22b outputs the vehicle speed dependent return speed NELV in accordance with the vehicle speed SPD. In each of the vehicle speed dependent return speed maps M22a and M22b, the vehicle speed dependent return speed NELV is one of two values, namely, a high return speed NELh and a low return speed NEL1. The high return speed NELh is higher than the minimum value of the water temperature dependent return speed NELW. When the air conditioner is in an activated state, a return lower limit value of the vehicle speed SPD at which the low return speed NEL1 is set to the vehicle speed dependent return speed NELV is higher than when the air conditioner in a deactivated state. This setting is made in consideration that variations in load torque applied to the crankshaft 28 readily increase when the air conditioner is in the activated state. Additionally, when the brake is in an activated state, the return lower limit value of the vehicle speed SPD at which the low return speed NEL1 is set to the vehicle speed dependent return speed NELV is lower than when the brake is in a deactivated state. However, regardless of whether the brake is in the activated state or the deactivated state, when the air conditioner is in the activated state, the return lower limit value of the vehicle speed SPD is greater than when the air conditioner is in the deactivated state.

Each of the vehicle speed dependent permit speed maps M30a and M30b is map data in which input variables are parameters indicating the air conditioner state, the brake state, whether or not the gear position is higher than or equal to the predetermined gear position, and the vehicle speed SPD and an output variable is the vehicle speed dependent permit speed NEHV. In the vehicle speed dependent permit speed map M30a of the present embodiment, similarly to the vehicle speed dependent return speed map M22a, the vehicle speed dependent permit speed NEHV is defined only when the gear position is “H.” However, in the vehicle speed dependent permit speed M30b, similarly to the vehicle speed dependent return speed map M22b, the vehicle speed dependent permit speed NEHV is defined also when the gear position is “L.”

Each of the vehicle speed dependent permit speed maps M30a and M30b outputs the vehicle speed dependent permit speed NEHV in accordance with the vehicle speed SPD. In each of the vehicle speed dependent permit speed maps M30a and M30b, the vehicle speed dependent permit speed NEHV is one of two values, namely, a high permit speed NEHh and a low permit speed NEH1. The high permit speed NEHh is greater than the minimum value of the water temperature dependent permit speed NEHW. When the air conditioner is in the activated state, a permit lower limit value of the vehicle speed SPD at which the low permit speed NEH1 is set to the vehicle speed dependent permit speed NEHV is greater than when the air conditioner is in the deactivated state. This setting is made for the same reason as the setting of the return lower limit value at which the low return speed NEL1 is set to the vehicle speed dependent return speed NELV. Additionally, when the brake is in the activated state, the permit lower limit value of the vehicle speed SPD at which the low permit speed NEH1 is set to the vehicle speed dependent return speed NELV is smaller than when the brake is in the deactivated state. However, regardless of whether the brake is in the activated state or the deactivated state, when the air conditioner is in the activated state, the permit lower limit value of the vehicle speed SPD is greater than when the air conditioner is in the deactivated state.

In the present embodiment, the map calculation of the vehicle speed dependent permit speed NEHV selects the low permit speed NEH1 when the vehicle speed SPD is greater than or equal to the permit lower limit value, and selects the high permit speed NEHh when the vehicle speed SPD is less than the permit lower limit value. The map calculation of the vehicle speed dependent return speed NELV selects the low return speed NEH1 when the vehicle speed SPD is greater than or equal to the return lower limit value, and selects the high return speed NELh when the vehicle speed SPD is less than the return lower limit value. In other words, an interpolation calculation is not performed in the map calculations of the vehicle speed dependent permit speed NEHV and the vehicle speed dependent return speed NELV.

In FIG. 6, the solid lines show map calculation values of the vehicle speed dependent permit speed NEHV and the vehicle speed dependent return speed NELV in the wide map, and the broken lines show map calculation values of the vehicle speed dependent permit speed NEHV and the vehicle speed dependent return speed NELV in the normal map. FIG. 6 shows an example of a case where the air conditioner is in the activated state, the brake is in the deactivated state, and the gear position is “H.”

As shown in FIG. 6, the difference between the low permit speed NEH1 of the vehicle speed dependent permit speed NEHV and the low return speed NEL1 of the vehicle speed dependent return speed NELV in the wide map is smaller than the difference between the low permit speed NEH1 of the vehicle speed dependent permit speed NEHV and the low return speed NEL1 of the vehicle speed dependent return speed NELV in the normal map. This setting is made for the same reason as the setting of the hysteresis width hys. As shown in FIG. 6, the low return speed NEL1 of the wide map is lower than the low return speed NEL1 of the normal map, and the low permit speed NEH1 of the wide map is lower than the low permit speed NEH1 of the normal map. This setting is made in consideration that the decrease rate of the rotation speed of the crankshaft 28 at the time of execution of the fuel cut-off process is smaller when the crankshaft 28 is in the connected state than when the crankshaft 28 is in the disconnected state.

In the present embodiment, the high return speed NELh of the wide map is equal to the high return speed NELh of the normal map, and the high permit speed NEHh of the wide map is equal to the high permit speed NEHh of the normal map. When the vehicle speed SPD is low, the rotation speed of the input shaft 42 of the manual transmission 44 tends to lower. In this case, an engine stall may occur when the rotation speed of the input shaft 42 is lower than a target rotation speed of idle rotation speed control. Thus, the high return speed NELh of the wide map may not be set to a smaller value than the high return speed NELh of the normal map. Similarly, the high permit speed NEHh of the wide map may not be set to a smaller value than the high permit speed NEHh of the normal map.

As described above, the permit lower limit value of the vehicle speed SPD is the vehicle speed SPD at which the permit rotation speed NEH is switched from the low permit speed NEH1 to the high permit speed NEHh. The permit lower limit value of the vehicle speed SPD in the wide map is less than the permit lower limit value of the vehicle speed SPD in the normal map. As described above, the return lower limit value of the vehicle speed SPD is the vehicle speed SPD at which the return rotation speed NEL is switched from the low return speed NEL1 to the high return speed NELh. The return lower limit value in the wide map is set to a smaller value than the return lower limit value in the normal map. The reason for setting the permit lower limit value and the return lower limit value of the vehicle speed SPD in this manner will now be described. When the fuel cut-off process is started in the disconnected state of the crankshaft 28 and the user attempts switching the crankshaft 28 from the disconnected state to the connected state during the fuel cut-off process, an engine stall readily occurs if the rotation speed of the input shaft 42 is excessively low. On the other hand, when the crankshaft 28 continues to be in the connected state, an engine stall is less likely to occur unless the rotation speed of the input shaft 42 is excessively lower than the above-described target rotation speed.

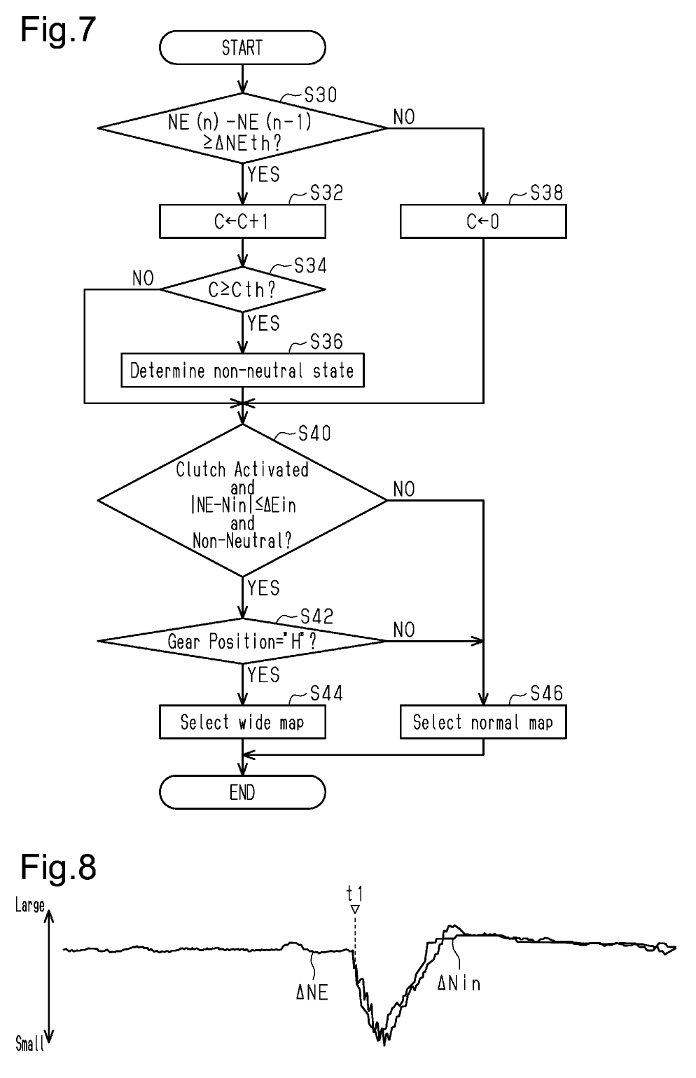

FIG. 7 shows the procedures of a selection process executed in the speed calculation process M12 for selecting the wide map and the normal map. The process shown in FIG. 7 is implemented under a program stored in the ROM 64 and executed by the CPU 62 repeatedly, for example, in a predetermined cycle.

In the series of processes shown in FIG. 7, the CPU 62 first determines whether or not a value obtained by subtracting a previous rotation speed NE(n−1) from a current rotation speed NE(n) of the rotation speeds NE, which are included in rotation speeds NE acquired whenever the series of processes shown in FIG. 7 is periodically executed, is greater than or equal to a specified value ΔNEth (S30). The specified value ΔNEth is a negative value. This process is executed to determine whether or not the decrease rate of the rotation speed NE is less than or equal to a specified rate. The decrease rate is a value that becomes positive when the rotation speed NE is decreasing. In the present embodiment, when the decrease rate is large, the value obtained by subtracting the previous rotation speed NE(n−1) from the current rotation speed NE(n), or the change speed, is negative and, the absolute value of the change speed is large.

When it is determined that the value of “NE(n)−NE(n−1)” is greater than or equal to the specified value ΔNEth (S30: YES), the CPU 62 increments a counter C (S32). The counter C counts the duration of a state in which the value of “NE(n)−NE(n−1)” is greater than or equal to the specified value ΔNEth. Subsequently, the CPU 62 determines whether or not the counter C is greater than or equal to a predetermined value Cth (S34). This process determines whether or not the duration of the state in which the value of “NE(n)−NE(n−1)” is greater than or equal to the specified value ΔNEth is longer than or equal to a predetermined time.

When it is determined that the counter C is greater than or equal to the predetermined value Cth (S34: YES), the CPU 62 determines that the manual transmission 44 is in a non-neutral state (S36). The process of S12 in FIG. 4 makes a positive determination when the accelerator operation amount ACCP is zero. The process of S36 in FIG. 7 is performed in consideration that, when the manual transmission 44 is in the non-neutral state, the rotation speed NE of the crankshaft 28 with the accelerator operation amount ACCP being zero does not decrease as readily as when the manual transmission 44 is in the neutral state.

When it is determined that the value of “NE(n)−NE(n−1)” is less than the specified value ΔNEth (S30: NO), the CPU 62 initializes the counter C to zero (S38).

When the process in S36 or S38 is completed or when a negative determination is made in the process in S34, the CPU 62 determines whether or not all of the following conditions (A), (B) and (C) are satisfied (S40).

Condition (A): the clutch 40 is in the coupled state

Condition (B): the absolute value of the difference between the rotation speed Nin of the input shaft 42 of the manual transmission 44 and the rotation speed NE of the crankshaft 28 is less than or equal to a predetermined value ΔEin

Condition (C): the non-neutral state of the manual transmission 44 is determined.

This process determines whether or not the output shaft 48 of the manual transmission 44 and the crankshaft 28 are in the connected state. The behavior of the rotation speed NE of the crankshaft 28 in the released state of the clutch 40 tends to be similar to the behavior of the rotation speed NE of the crankshaft 28 in the neutral state. However, even when the clutch 40 is in the released state, conditions (B) and (C) may be satisfied due to certain factors. Thus, condition (A) is determined in S40. The rotation speed Nin of the input shaft 42 is calculated by the CPU 62 based on the output signal Sin of the input rotation angle sensor 74.

When a positive determination is made in S40 (S40: YES), the CPU 62 determines whether or not the gear position is higher than or equal to a predetermined gear position (S42). In other words, the CPU 62 determines whether or not the gear position is “H” (S42). When it is determined that the gear position is higher than or equal to the predetermined gear position (S42: YES), the CPU 62 selects the wide map (S44). When a negative determination is made in the process of S40 or S42, the CPU 62 selects the normal map (S46).

When the process of S44 or S46 is completed, the CPU 62 temporarily ends the series of processes shown in FIG. 7.

As shown in FIG. 2, the speed calculation process M12 includes a maximum value selection process M24 and a maximum value selection process M32. After the wide map or the normal map is selected, the maximum value selection process M24 selects the higher one of the water temperature dependent return speed NELW calculated by the map calculation and the vehicle speed dependent return speed NELV calculated by the map calculation and sets the selected speed to the return rotation speed NEL. The maximum value selection process M32 selects the higher one of the water temperature dependent permit speed NEHW output in the addition process M28 and the vehicle speed dependent permit speed NEHV calculated by the map calculation and sets the selected speed to the permit rotation speed NEH.

The operation and effect of the present embodiment will now be described.

FIG. 8 shows a change amount ΔNE of the rotation speed NE of the crankshaft 28 per unit time and a change amount ΔNin of the rotation speed Nin of the input shaft 42 per unit time when the user operates the shift lever 46 to set the manual transmission 44 to neutral in a state in which the accelerator operation amount ACCP is zero. The change amount ΔNE is a value calculated in the process of S30. As shown in FIG. 8, at time t1, when the manual transmission 44 comes into the neutral state in the state in which the accelerator operation amount ACCP is zero, the change amount ΔNE of the rotation speed NE decreases. Thus, the CPU 62 makes a negative determination in the process of S30 in FIG. 7 and therefore does not perform a non-neutral determination in S36. As a result, the CPU 62 determines the permit rotation speed NEH and the return rotation speed NEL by using the normal map.

When several conditions, for example, a condition that the decrease rate of the rotation speed NE is small (S30: YES) in a state in which the accelerator operation amount ACCP is determined to be zero by the process of S12 in FIG. 4, the CPU 62 determines the permit rotation speed NEH and the return rotation speed NEL by using the wide map. As a result, even when the rotation speed NE of the crankshaft 28 is lower than the rotation speed NE in the case of using the normal map, the CPU 62 determines that the execution conditions of the fuel cut-off process are satisfied and executes the fuel cut-off process. This limits the adverse effect on the drivability. More specifically, if the fuel cut-off process is not executed in the connected state of the crankshaft 28, braking operations will be frequently performed on a downhill where a small amount of deceleration is made. This adversely affects the drivability.

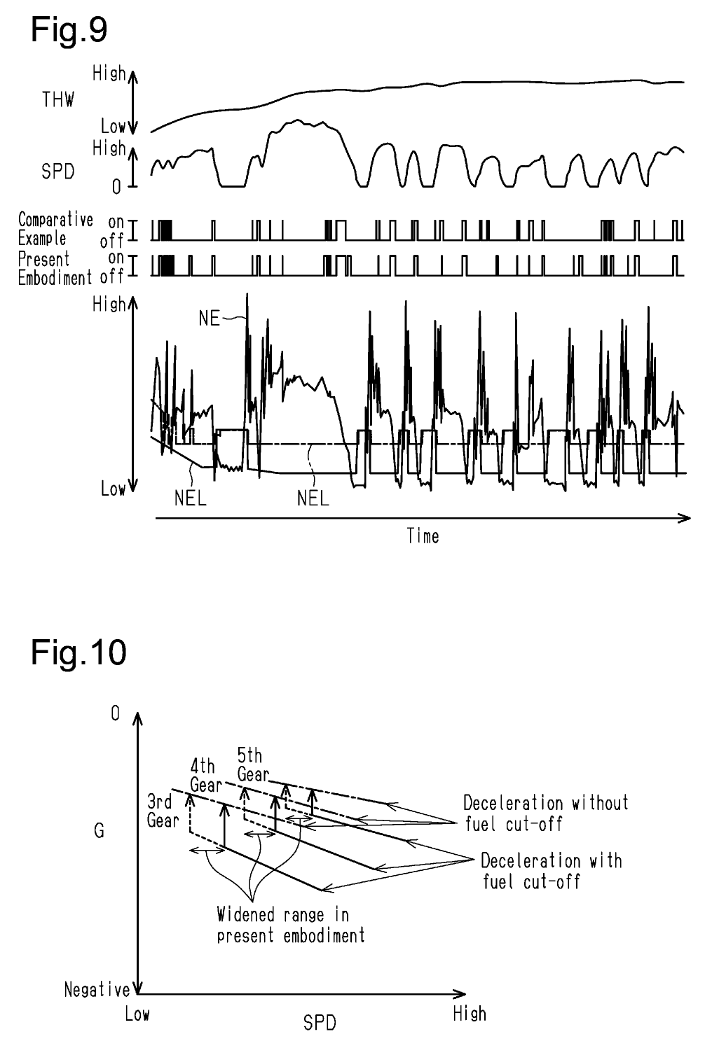

FIG. 9 shows the execution and non-execution (on and off in FIG. 9) of the fuel cut-off process in the present embodiment and a comparative example that uses only the normal map, the return rotation speed NEL in the present embodiment (solid line), and the return rotation speed NEL in the comparative example (single-dashed line). As shown in FIG. 9, the fuel cut-off process is more frequently executed in the present embodiment than in the comparative example. According to the present embodiment, for example, the return rotation speed NEL is set to lower speeds so that the duration of the fuel cut-off process is longer than that of the comparative example.

In the present embodiment, the duration of the fuel cut-off process is increased. This further decreases an acceleration G when the accelerator operation amount ACCP is zero and allows the user to have a favorable deceleration feel. In FIG. 10, the single-dashed lines show the acceleration G when the fuel cut-off process is not executed with the accelerator operation amount ACCP being zero, the solid lines show the acceleration G when the fuel cut-off process is executed in the disconnected state, and the broken and solid lines show the acceleration G when the fuel cut-off process is executed in the connected state. FIG. 10 shows an example of setting in which the gear position is “H” at the third and higher gear positions. Thus, FIG. 10 shows the acceleration G at the third and higher gears.

As indicated by the broken lines in FIG. 10, in the present embodiment, the return rotation speed NEL is set to lower speeds. Thus, when the fuel cut-off process is stopped, the vehicle speed SPD is a lower speed. Switching from a state in which the fuel cut-off process is executed to a state in which the fuel cut-off process is stopped and the fuel injection is resumed abruptly changes the torque. When the vehicle speed SPD is low, such an abrupt change in torque is smaller than when the vehicle speed SPD is high. The abrupt change in torque caused by a stop of the fuel cut-off process is reduced by setting the return rotation speed NEL to a lower speed. If the return rotation speed NEL is not set to a lower speed in the connected state, stops of the fuel cut-off process produce noticeable abrupt changes in torque more frequently at the vehicle speed SPD around, for example, 30 km/h to 40 km/h.

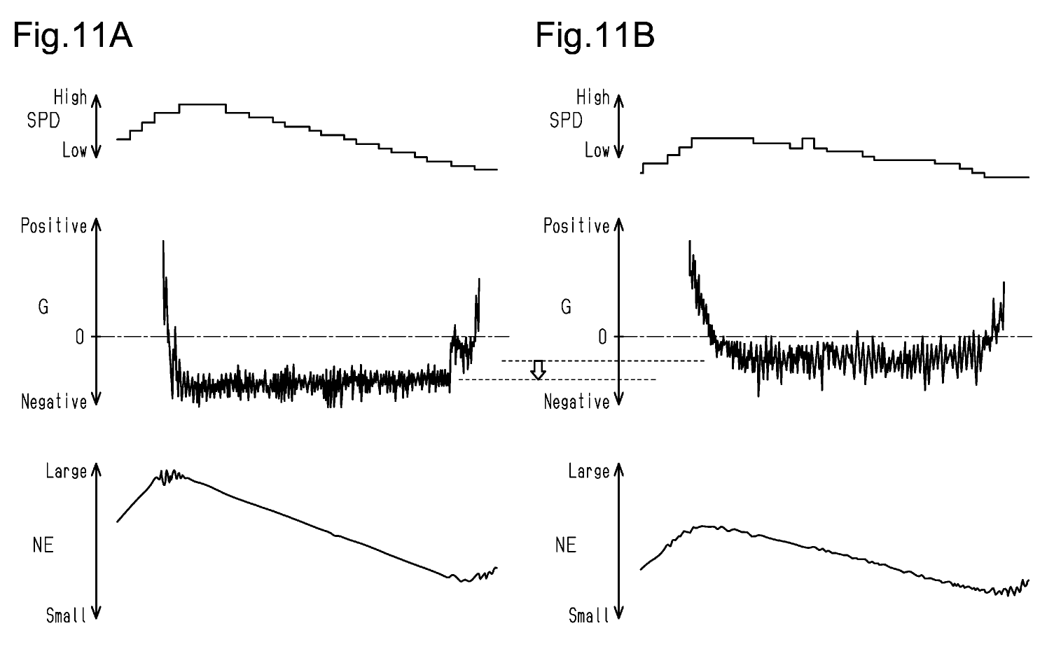

FIG. 11A shows the vehicle speed SPD, the acceleration G of the vehicle, and the rotation speed NE when the fuel cut-off process is executed particularly at the fourth gear. FIG. 11B shows the vehicle speed SPD, the acceleration G of the vehicle, and the rotation speed NE when the fuel cut-off process is not executed at the fourth gear. As shown in FIGS. 11A and 11B, when the fuel cut-off process is executed, the acceleration G of the vehicle is smaller than when the fuel cut-off process is not executed. In other words, the deceleration of the vehicle increases.

### Correspondence

The matters described in the above embodiment correspond to the matters described in “SUMMARY” as follows.

Described below are the respective correspondences for each number of the aspects described in “SUMMARY.”

[1], [7], and [8] The widening process corresponds to the process of S44.

[2] The widening process corresponds to the process based on the settings of the hysteresis width maps M26a and M26b shown in FIG. 5 and the process based on the settings of the vehicle speed dependent return speed maps M22a and M22b and the vehicle speed dependent permit speed maps M30a and M30b shown in FIG. 6.

[3] The temperature reflection process corresponds to the process based on the settings of the water temperature dependent return speed maps M20a and M20b shown in FIG. 5.

[4] The vehicle speed reflection process corresponds to the process based on the settings of the vehicle speed dependent return speed maps M22a and M22b and the vehicle speed dependent permit speed maps M30a and M30b shown in FIG. 6.

[5] Aspect 5 corresponds to the process of S42.

[6] Aspect 6 corresponds to the process of S40.

### Other Embodiments

The present embodiment may be modified in following manners. The present embodiment and the following modifications may be practiced in combination with each other as long as no technical inconsistency is produced by the combinations.

### “Temperature Reflection Process”

In the above embodiment, the water temperature THW is used as the temperature of the internal combustion engine 10. However, the water temperature THW is not required to be used. For example, the temperature of a lubricant in the internal combustion engine 10 may be used as the temperature of the internal combustion engine 10.

In the above embodiment, the water temperature dependent return speed NELW is continuously changed in accordance with the water temperature THW, which is used as the temperature of the internal combustion engine 10. However, the change is not required to be made in this manner. For example, the interpolation calculation may be eliminated from the map calculation. For example, the map calculation may output a value of an output variable corresponding to a value of an input variable closest to the actual water temperature THW from the values of the input variables in the map data. In this case, the water temperature dependent return speed NELW is changed in a stepped manner in accordance with the water temperature THW. In this case, the water temperature dependent return speed NELW may be changed in one or more steps.

The process that changes the water temperature dependent return speed NELW in accordance with the water temperature THW is not essential. The vehicle speed dependent return speed NELV may be set to the return rotation speed NEL.

### “Vehicle Speed Reflection Process”

In the above embodiment, the vehicle speed dependent return speed NELV is selected from the two values, namely, the low return speed NEL1 and the high return speed NELh. However, the vehicle speed dependent return speed NELV is not required to be selected from the two values. For example, the vehicle speed dependent return speed NELV may be selected from three values.

In the above embodiment, the vehicle speed dependent return speed NELV is variably set based on the air conditioner state, the brake state, and the gear position. However, the vehicle speed dependent return speed NELV is not required to be set based on these states. For example, the vehicle speed dependent return speed NELV may be variably set based on only two of the three parameters or may be variably set based on only one parameter. Alternatively, the vehicle speed dependent return speed NELV may be variably set based on none of the three parameters.

Furthermore, the process that changes the vehicle speed dependent return speed NELV in accordance with the vehicle speed SPD is not essential. For example, in the above embodiment, the vehicle speed SPD may be eliminated from the variable setting of the vehicle speed dependent return speed NELV. That is, the vehicle speed dependent return speed NELV may be variably set in accordance with at least one of the air conditioner state, the brake state, and the gear position. Moreover, for example, the water temperature dependent return speed NELW may be set to the return rotation speed NEL.

### “Permit Rotation Speed NEH”

In the above embodiment, the water temperature dependent permit speed NEHW is continuously changed in accordance with the water temperature THW, which is used as the temperature of the internal combustion engine 10. However, this change is not required to be made in this manner. For example, the interpolation calculation may be eliminated from the map calculation. For example, the map calculation may output a value of an output variable corresponding to a value of an input variable closest to the actual water temperature THW from the values of the input variables in the map data. In this case, the water temperature dependent permit speed NEHW is changed in a stepped manner in accordance with the water temperature THW. In this case, the water temperature dependent permit speed NEHW may be changed in one or more steps.

Furthermore, the process that changes the water temperature dependent permit speed NEHW in accordance with the water temperature THW is not essential. Thus, the vehicle speed dependent permit speed NEHV may be set to the permit rotation speed NEL.

In the above embodiment, the vehicle speed dependent permit speed NEHV is selected from the two values, namely, the low permit speed NEH1 and the high permit speed NEHh. However, the vehicle speed dependent permit speed NEHV is not required to be selected from the two values. For example, the vehicle speed dependent permit speed NEHV may be selected from three values.

In the above embodiment, the vehicle speed dependent permit speed NEHV is variably set based on the air conditioner state, the brake state, and the gear position. However, the vehicle speed dependent permit speed NEHV is not required to be set based on these states. For example, the variable setting may be made based on only two of the three parameters or based on only one of the three parameters. Alternatively, the variable setting may be made on none of these parameters.

Furthermore, the process that changes the vehicle speed dependent permit speed NEHV in accordance with the vehicle speed SPD is not essential. For example, the vehicle speed dependent permit speed NEHV in the embodiment described above may be variably set based on at least one of the air conditioner state, the brake state, and the gear position, but not based on the vehicle speed SPD. In addition, the water temperature dependent permit speed NEHW may be set to, for example, the permit rotation speed NEH.

### “Widening Process”

In FIG. 6, the return lower limit value of the vehicle speed SPD at which the value of the vehicle speed dependent return speed NELV determined by the normal map is switched is set to be the same as the permit lower limit value of the vehicle speed SPD at which the vehicle speed dependent permit speed NEHV determined by the wide map is switched. However, this setting is not required to be used. For example, the permit lower limit value of the vehicle speed SPD at which the value of the vehicle speed dependent permit speed NEHV determined by the wide map is switched may be set to a value greater than the return lower limit value of the vehicle speed SPD at which the value of the vehicle speed dependent return speed NELV determined by the normal map is switched. In this case, the normal map and the wide map may use the same return lower limit value of the vehicle speed SPD at which the value of the vehicle speed dependent return speed NELV is switched.

FIG. 6 shows an example of a case where each of the two values, namely, the low return speed NEL1 and the low permit speed NEH1 is smaller in the wide map than in the normal map. However, these speeds are not required to be set in this manner. For example, only the low return speed NEL1 may have a smaller value in the wide map than in the normal map.

### “Controller”

The controller is not limited to a device that includes the CPU 62 and the ROM 64 to execute software processes. For example, a dedicated hardware circuit (e.g., application specific integrated circuit (ASIC)) for processing at least some of the software processes executed in the above embodiment may be provided. Accordingly, the controller may have any of the following configurations (a) to (c). Configuration (a) includes a processing device for executing all of the above processing under a program and a program storage device such as a ROM for storing the program. Configuration (b) includes a processing device for executing some of the above processes in accordance with a program and a program storage device and a dedicated hardware circuit for executing the remaining processes. Configuration (c) includes a dedicated hardware circuit for executing all of the above processes. Multiple software circuits including the processing device and the program storage device and multiple dedicated hardware circuits may be provided. More specifically, the processes described above may be executed by processing circuitry that includes at least one of one or more software circuits or one or more dedicated hardware circuits. The program storage device, or a computer readable medium, includes any available media accessible by a general-purpose or dedicated computer.

### “Others”

The internal combustion engine is not limited to a spark ignition type internal combustion engine and may be a compression ignition type internal combustion engine such as a diesel engine. In the case of the compression ignition type internal combustion engine, a process that gradually advances the injection timing from the retarded state may be executed as a process that gradually increases the shaft torque of the internal combustion engine 10 so that the abrupt change in torque is reduced at a stop of the fuel cut-off process.

Therefore, the present examples and embodiments are to be considered as illustrative and not restrictive and the invention is not to be limited to the details given herein, but may be modified in the scope and equivalence of the appended claims.

1. A controller for an internal combustion engine, the internal combustion engine being mounted on a vehicle and including a crankshaft, the crankshaft being configured to be connected to a manual transmission via a clutch,
the controller comprising processing circuitry, wherein
the processing circuitry is configured to perform
executing a fuel cut-off process that stops supply of fuel to a combustion chamber of the internal combustion engine when an accelerator operation amount is less than or equal to a predetermined amount and a rotation speed of the crankshaft is in a predetermined speed range,
setting a lower limit value of the predetermined speed range to a permit rotation speed during non-execution of the fuel cut-off process,
setting the lower limit value of the predetermined speed range to a return rotation speed during execution of the fuel cut-off process, the return rotation speed being lower than the permit rotation speed, and
executing an widening process that widens the predetermined speed range when a decrease rate of the rotation speed of the crankshaft is less than or equal to a specified rate as compared to when the decrease rate is greater than the specified rate, wherein the widening process includes a process that lowers at least one of the permit rotation speed and the return rotation speed.

2. The controller for the internal combustion engine according to claim 1, wherein the widening process includes a process that sets a difference between the permit rotation speed and the return rotation speed to a smaller value when the decrease rate is less than or equal to the specified rate than when the decrease rate is greater than the specified rate.

3. The controller for the internal combustion engine according to claim 1, wherein
the processing circuitry is configured to execute a temperature reflection process that sets the return rotation speed to a larger value when a temperature of the internal combustion engine is low than when the temperature of the internal combustion engine is high,
when the temperature of the internal combustion engine is a first temperature, the return rotation speed is a first return rotation speed,
when the temperature of the internal combustion engine is a second temperature that is lower than the first temperature, the return rotation speed is a second return rotation speed, and
the widening process includes a process that sets a difference between the first return rotation speed and the second return rotation speed to a smaller value when the decrease rate is less than or equal to the specified rate than when the decrease rate is greater than the specified rate.

4. The controller for the internal combustion engine according to claim 1, wherein
the processing circuitry is configured to execute a vehicle speed reflection process that sets the return rotation speed to a larger value when a vehicle speed is low than when the vehicle speed is high,
the vehicle speed reflection process includes a process that sets the return rotation speed to a larger value when the vehicle speed is lower than a predetermined vehicle speed than when the vehicle speed is greater than or equal to the predetermined vehicle speed, and
the widening process includes a process that sets the predetermined vehicle speed to a further lower value when the decrease rate is less than or equal to the specified rate than when the decrease rate is greater than the specified rate.

5. The controller for the internal combustion engine according to claim 1, wherein the widening process includes a process that lowers the return rotation speed on a condition that a gear position of the manual transmission is a predetermined gear position or higher.

6. The controller for the internal combustion engine according to claim 1, wherein the widening process includes a process that widens the predetermined speed range on a condition that a clutch sensor detects that the clutch is in a coupled state.

7. A method for controlling an internal combustion engine, the internal combustion engine being mounted on a vehicle and including a crankshaft, the crankshaft being configured to be connected to a manual transmission via a clutch,
the method comprising:
executing a fuel cut-off process that stops supply of fuel to a combustion chamber of the internal combustion engine when an accelerator operation amount is less than or equal to a predetermined amount and a rotation speed of the crankshaft is in a predetermined speed range;
setting a lower limit value of the predetermined speed range to a permit rotation speed during non-execution of the fuel cut-off process;
setting the lower limit value of the predetermined speed range to a return rotation speed during execution of the fuel cut-off process, the return rotation speed being lower than the permit rotation speed; and
executing an widening process that widens the predetermined speed range when a decrease rate of the rotation speed of the crankshaft is smaller than or equal to a specified rate as compared to when the decrease rate is greater than the specified rate, wherein the widening process includes a process that lowers at least one of the permit rotation speed and the return rotation speed.

8. A controller for an internal combustion engine, the internal combustion engine being mounted on a vehicle and including a crankshaft, the crankshaft being configured to be connected to a manual transmission via a clutch,
the controller comprising processing circuitry configured to execute a fuel cut-off process that stops supply of fuel to a combustion chamber of the internal combustion engine, wherein the processing circuitry is configured to perform:
executing the fuel cut-off process when an accelerator operation amount is less than or equal to a predetermined amount and a rotation speed of the crankshaft is greater than or equal to a permit rotation speed during non-execution of the fuel cut-off process;
stopping the fuel cut-off process when the accelerator operation amount is larger than the predetermined amount or the rotation speed of the crankshaft is lower than a return rotation speed during execution of the fuel cut-off process, the return rotation speed being lower than the permit rotation speed; and
executing a process that lowers at least one of the permit rotation speed and the return rotation speed when a decrease rate of the rotation speed of the crankshaft is less than or equal to a specified rate.
